(19) United States
(12) Patent Application Publication
(10) Pub. No.: US 2025/0164152 A1
(43) Pub. Date: May 22, 2025

(54) ABSORBER UNIT, MIRROR UNIT AND SOLAR COLLECTOR OR SOLAR INSTALLATION

(71) Applicant: Martin HADLAUER, Graz (AT)

(72) Inventor: Martin HADLAUER, Graz (AT)

(21) Appl. No.: 18/847,351

(22) PCT Filed: Mar. 15, 2023
(86) PCT No.: PCT/EP2023/056682

§ 371 Date: Sep. 16, 2024

(30) Foreign Application Priority Data
Mar. 15, 2022 (AT) A 60039/2022

(51) Int. Cl. F24S 20/20; F24S 10/20; F24S 10/40; F24S 23/70; F24S 25/60; F28D 15/04; H02S 40/44

(52) U.S. Cl. CPC F24S 20/20; F24S 10/20; F24S 10/45; F28D 15/04; F24S 23/70; F24S 25/60; H02S 40/44

(57) ABSTRACT

An absorber unit including at least one heater element, a transparent enclosure, and a mount for the enclosure. The mount includes an inner tube and an outer tube. The invention also relates to a mirror unit including at least one reinforcement having a concave reinforcement element, wherein an upper mirror is fastened to an inner side of the reinforcement element and/or a lower mirror is fastened to an outer side of the reinforcement element. The invention also relates to a solar collector or solar installation including at least one support arm for receiving a mirror unit and/or an absorber unit.

### CROSS-REFERENCE TO RELATED APPLICATIONS

The present application is a national phase application of PCT Application No. PCT/EP2023/056682, filed Mar. 15, 2023, entitled “ABSORBER UNIT, MIRROR UNIT AND SOLAR COLLECTOR OR SOLAR INSTALLATION”, which claims the benefit of Austrian Patent Application No. A 60039/2022, filed Mar. 15, 2022, each of which is incorporated by reference in its entirety.

### BACKGROUND OF THE INVENTION

### 1. Field of the Invention

The subject matter of the invention is an overall unit, here called a mirror unit, comprising an absorber unit, mirror, holding arm and an automatic cleaning device together with all wiring, insulation and special details of individual components.

These mirror units can now be mounted on different brackets, especially tracking frames. For example, there will be collector systems with two, four and eight mirror units. There are several variants of solar heaters. For example, there will be absorber units that provide instantaneous water heaters for heating liquid and gaseous heat transfer media. Another variant, for example, provides for a solar heater to evaporate a condensate.

### SUMMARY OF THE INVENTION

An essential task of the invention is to generate high-temperature heat with the lowest possible thermal losses and to transmit this heat via appropriately insulated lines or to bring it to a station. All cables are laid inside the support arms and can be covered with high-temperature insulation. Additional foaming of the interior provides further thermal insulation and enables the cables to be positioned ready for connection. The system should withstand temperatures up to 400° C. and pressures up to 50 bar. The selection of suitable materials can be made depending on the temperature requirements. It is important to take into account the thermal expansion of the pipes by providing expansion compensators. The frame of a glass dome of the mirror unit should not come into contact with heated parts. Thermal bridges from the pipes to the suspensions and between the pipes must be avoided or minimized. The mirrors concentrate the sun about 25 times. Depending on the beam position on the mirror (upper edge or center), a steradian of 5 to 150 around the core radiation of the sun is captured. This also captures the diffuse radiation in the immediate vicinity of the sun. The absorber glass can be shaped accordingly so that the direct radiation hits the glass surface essentially normally in all areas.

A knock-out criterion for many elevated systems is often the free wind attack area.

In systems with eight mirror units, the outer mirrors can swivel 180° and seal against the inner mirrors. In this way, an ideal protective position can be achieved with the wind attack surface halved. In order to withstand extreme wind loads of 150 to 250 km/h, the mirrors can also be removed. A decisive criterion is the quick and easy assembly and disassembly of the mirrors.

One object of the invention is achieved by an absorber unit for a solar collector or a solar system, wherein the absorber unit comprises at least
a heating element, which heating element for guiding a heat transfer medium,
a translucent frame, in which frame the at least one Heating element, preferably all heating elements, is or are arranged, and
a holder for the casing, wherein the holder comprises an inner pipe and an outer pipe radially spaced from the inner pipe, wherein the casing is fastened to the outer pipe, and wherein a supply line and/or a return line for the heat transfer medium is or are guided in the inner pipe.

Damage to the casing due to heat and corresponding expansion stresses can thus be avoided, since the casing is not attached to the hot part of the bracket, which part houses the hot flow line, but to a comparatively cold part of the bracket, which cold part is formed by the outer pipe, whereby the outer pipe is separated/heat-insulated from the inner pipe by a (vacuum) annular gap. The frame is usually made of glass and should be transparent for at least one spectral range of electromagnetic radiation.

Preferably, the enclosure is formed by a glass dome. This gives the frame the desired optical properties in terms of the required light transmission and at the same time a certain stability and resistance to breakage.

It is preferably provided that an annular gap, in particular a vacuum annular gap, is formed between the inner tube and the outer tube, which annular gap opens into a receiving volume of the enclosure, and wherein the inner tube is closed, preferably vacuum-tight, at an end facing the receiving volume.

This increases the efficiency of the absorber unit due to thermal insulation and the avoidance of thermal bridges.

It is preferably provided that a receptacle for the heating element, in particular a welding receptacle, closes the inner tube at its end facing the receiving volume, preferably in a vacuum-tight manner. This allows the thermal insulation to be improved even further; at the same time, the holder enables a stable arrangement of the heating elements in the receiving volume of the enclosure.

It is preferably provided that the annular gap is closed, preferably vacuum-tight, at an end of the holder facing away from the receiving volume. Thus, heat conduction from the hot end of the inner tube, which hot end can be arranged in the receiving volume or faces it, to the cold end of the outer tube, at which cold end the surround engages or is arranged, is possible; however, the distance between these two areas is kept to a maximum by the connection of the inner tube to the outer tube, which is only arranged at the end, so that—if a material with a correspondingly poor thermal conductivity is selected—no noticeable heating of the end of the outer tube used to attach the surround can take place.

Preferably, the inner tube is welded to the outer tube at the end of the holder facing away from the receiving volume. This ensures a particularly stable connection between the inner and outer tubes, which at the same time enables the described advantages of a secure fastening of the edging.

Preferably, the inner tube projects beyond the outer tube with its end facing the receiving volume. This allows the inner tube to extend into the receiving volume of the enclosure, allowing a more stable and exposed arrangement of the heating element (or all heating elements) to be achieved. This means that the efficiency of the absorber unit, or of a solar system or solar collector comprising the absorber unit, can be improved even further.

It is preferably provided that the heating element is formed by a heat exchanger or comprises the same. It is preferably provided that the heating element is formed by or comprises a continuous flow heater with tubular coils. Preferably, the heating element is formed by or comprises a two-phase thermosiphon. Preferably, the heating element is formed by a heat pipe or comprises the same. In this way, a particularly efficient heating of the heat transfer medium can be achieved.

Preferably, the heat pipe comprises a pressure vessel, a capillary suction layer or lining, an outer tube for discharging the heat transfer medium from the pressure vessel, wherein the outer tube has an outlet opening opening outside the pressure vessel, and an inner tube for supplying the heat transfer medium into the pressure vessel, wherein the inner tube has a first outlet, in particular a lower outlet, and a second outlet, in particular an upper outlet, wherein the first outlet and the second outlet open within the pressure vessel. This advantageous design of the heat pipe enables particularly efficient energy and heat generation through the absorber unit.

Preferably, a distribution unit is provided with several, for example five, receptacles, in or on each of which a heat pipe is fastened, wherein the distribution unit establishes a (fluidic) connection between the inner tube and the outer tube of the heat pipes accommodated in or on the receptacles on the one hand and the supply line and the return line on the other hand. In this way, on the one hand, a particularly stable and exposed storage of the heating elements in the receiving volume of the absorber element can be realized, and at the same time, a simple, tight and reliable fluidic connection between the supply and return lines and the individual heating elements can be realized.

Preferably, the distributor unit forms the receptacle for the heating element. Thus, the distribution unit also takes over the function of closing the inner tube on the receiving volume side.

It is preferably provided that the absorber unit comprises at least one reflector, wherein the at least one heating element, preferably each heating element, is arranged between the reflector and the enclosure. In this way, the heating elements in the absorber unit's receiving volume can be heated as evenly as possible.

Preferably, the reflector is attached to the holder for the heating element or to the distributor unit and the reflector extends in the longitudinal direction of the heating element.

This allows a stable and reliable mounting of the reflector and at the same time a high efficiency of the absorber unit to be achieved.

It is preferably provided that the at least one heating element, preferably all heating elements, is or are connected to heat-conducting vanes or formed integrally therewith in order to increase the proportion of solar radiation absorbed by the heating element. The heat-conducting wings are preferably made of a highly thermally conductive material and enable even more efficient use of the energy flow entering the enclosure.

It is preferably provided that the heat conducting vanes of adjacent heating elements touch each other or are formed integrally with each other. This allows the efficiency of the absorber unit to be further increased.

It is preferably provided that the heat-conducting wings have solar cells on an outer side facing the enclosure, preferably this outer side is completely covered with solar cells.

In this way, photovoltaics can also be used in addition to thermal energy generation.

Preferably, the holder is provided with a counter flange for screwing the absorber unit to a holding flange of a support arm of the solar collector or the solar system and/or holding bolts for engaging in guide slots of a support arm of the solar collector or the solar system and/or guide slots for receiving holding bolts of a support arm of the solar collector or the solar system. This allows for a particularly simple and reliable attachment of the absorber unit to the support arm.

Preferably, it is provided that a line outlet (located away from the enclosure) of the flow line and/or the return line has threads for fastening one or more sliding sleeves in order to sealingly connect the flow line and/or the return line to an internal piping of a support arm of the solar collector or the solar system. Due to the fastening option for sliding sleeves, these can be used as expansion compensators, which absorb the thermal expansion of the lines from the support arm and/or the line outlet of the supply line and/or the return line. This improves the tightness of the solar system or collector and prevents leaks and losses.

One object of the invention is achieved by a mirror unit for a solar collector or a solar system, wherein the mirror unit comprises at least one stiffener with a concave stiffening element, wherein an upper mirror is fastened, in particular glued, to an inner side of the stiffening element and/or a lower mirror is fastened, in particular glued, to an outer side of the stiffening element, wherein the mirror unit further comprises a closure element, which closure element is connected to the stiffening element or is formed in one piece with it and forms a closure opening, wherein the closure element has means for releasably fastening the mirror unit to a support arm of the solar collector or the solar system. The locking element enables particularly easy assembly and disassembly of the mirror unit on the support arm or the solar system/solar collector. The part of the mirror unit that is attached to the support arm is structurally reinforced by the stiffening element; however, the fact that this stiffening is only provided in one (central) section of the mirror unit or the mirrors means that weight can be saved. The locking opening also allows the passage of other components of the solar system/solar collector, such as the absorber unit, which can be attached to the support arm before the mirror unit is attached. In particular, this design also enables separate handling, in particular assembly and disassembly, of the mirror unit and the absorber unit.

It is preferably provided that the stiffening, in particular the stiffening element, only partially rests on the upper mirror and/or the lower mirror. Thus, structural reinforcement of the mirror unit is only provided in the area providing the attachment, while outside of this area, corresponding reinforcements (which have a negative impact on the overall weight) can be dispensed with. This allows the overall weight of the mirror unit to be significantly reduced. Preferably, the stiffening or stiffening element overlaps the upper mirror and/or the lower mirror only in a partial area, which partial area forms no more than 30%, preferably no more than 20%, in particular less than 10%, of an outer surface of the upper mirror and/or the lower mirror.

Preferably, a filling, in particular a foam, is arranged between the upper mirror and the lower mirror. This can protect the mirror surface and increase the stability of the mirror unit.

It is preferably provided that the closure opening, in particular the closure element, is welded to the stiffener, in particular the stiffening element, or is connected to the stiffener, in particular the stiffening element, by a die-casting process. The stiffening element can, for example, be designed as a welded part or as an (aluminum) die-cast part or as a (plastic) injection-molded part. This allows the locking element and stiffening element to be connected to each other in a particularly reliable and stable, but at the same time cost-effective manner.

It is preferably provided that the closure element has a, preferably circumferential, guide recess, which guide recess is designed to accommodate one or several bolts of a holding flange of the support arm and comprises a stop, in particular a jaw, for defining a stop position of a bolt, and the closure element further comprises a locking element, in particular a locking bolt, for locking the bolt in the stop position. The mirror unit can be mounted with an upper limit of the guide recess, i.e. with the locking element, on or on the bolt of the holding flange. This design allows for a particularly simple fastening that can be made and released again quickly, namely by means of a bayonet lock.

It is preferably provided that the closure element has insertion openings to enable the bolts to be inserted into the guide recess. The arrangement of the guide recesses also allows a desired rotational position to be defined in which the mirror unit is to be connected to the holding flange. This makes it easier to coordinate the mirror unit and the absorber unit.

Preferably, the lower mirror covers a rear side of the upper mirror facing the stiffener only in sections or segments. This allows costs to be saved, since the costs for the deep-drawing tool of a segment are many times lower than in the case of a full mirror. Furthermore, the degree of deformation can be kept relatively low.

One object of the invention is achieved by a solar collector or a solar system, comprising at least one support arm for receiving a mirror unit and/or an absorber unit, wherein the support arm has at least one support tube, which support tube is connected to a post or a tracking unit of the solar collector or the solar system, and at least one holding flange for releasably fastening the mirror unit to the support arm, wherein the holding flange has at least one radially protruding holding bolt on one end face. In this way, a bayonet lock can be created between the support arm and the mirror unit; the retaining bolt(s) can engage in the guide recess of the locking element when the mirror unit is placed on the retaining flange and by locking at least one retaining bolt, the mirror unit can be fixed in a specific rotational position on the retaining flange. After releasing the lock and turning the mirror unit in the opposite direction, it can be lifted off the holding flange again. Preferably, the retaining flange has through holes to enable a screw connection between the support arm and a counter flange of the absorber unit. This ensures that the absorber unit is securely attached.

It is preferably provided that the support arm has at least one guide slot to enable a bayonet lock between the support arm and a holder of the absorber unit. This ensures rapid assembly and disassembly of the absorber unit on or from the support arm.

It is preferably provided that the front side of the retaining flange is covered by a seal at least in sections, preferably over its entire surface, wherein the retaining bolts pierce a front-side sealing element of the seal. This seal can be used to protect the locking element of a mirror unit attached to the mounting flange from water ingress and contamination on the front side.

Preferably, the seal has a projection adjoining the front-side sealing element and extending radially outward, which projection forms a sealing lip engaging under the retaining bolts. This prevents water from entering through the insertion openings of the locking element.

It is preferably provided that a mirror unit according to one of the described embodiments is fastened to the support arm, wherein the holding flange is received in the closure opening of the mirror unit and the at least one, preferably all, holding bolts are received in the closure element of the mirror unit. This means that the retaining bolts of the retaining flange are located within the guide recess and enable the mirror unit to be mounted on the support arm. In addition, the locking of at least one bolt to the stop of the guide recess prevents the mirror unit from twisting relative to the holding flange and thus—since the insertion openings are arranged outside the stop position of the bolts—also prevents (unintentional) loosening of the connection between the mirror unit and the holding flange.

It is preferably provided that an absorber unit according to one of the described embodiments is fastened to the support arm, wherein the counter flange is screwed to the holding flange and/or wherein at least one of the holding bolts of the absorber unit engages in a guide slot of the support arm in order to form a bayonet lock between the absorber unit and the support arm. This allows to mount or remove the absorber unit from the support arm independently of the mirror unit.

Preferably, a diameter of the closure opening of the mirror unit is selected such that the absorber unit can be guided through the closure opening. This allows the mirror unit and absorber unit to be assembled and disassembled in any order.

It is preferably provided that a diameter of the closure opening is selected to be larger than a diameter of the enclosure, in particular the glass dome. This means that the absorber unit can be mounted on the support arm, for example, before the mirror unit is attached, without the risk of damage; the mirror unit can also be removed from the support arm before the absorber unit. Overall, the handling of the solar system/solar collector according to the invention can be simplified or improved.

The mirrors can have a central stiffener with an annular quick-release fastener so that they can be mounted and dismounted purely by twisting a retaining flange of the support arm, whereby the diameter of the annular locking opening is larger than the maximum diameter of the glass dome.

This allows the mirrors to be threaded in and out over the absorber units.

If the mirrors are pointing downwards, they can easily be removed or mounted by two people, as they weigh about 25 to 30 kg. Due to the independent installation of the mirror and absorber unit, the hydraulic circuit does not have to be opened. The support flange of the support arm and the central stiffener (mirror stiffener) form a bayonet lock, which can be opened by rotating the mirror by a small angle after opening a locking bolt. The bayonet lock is sealed, with a seal providing centering. Further details are in the figure description.

The absorber units can be attached to the support arm. This can be done by a sealed flange connection with through holes on the retaining flange, or also by a bayonet lock. The hydraulic connection can be made via two sealing elements, in particular sliding sleeves, which can be screwed onto the line outlets of the absorber. The sealing elements, especially sliding sleeves, are sealing when screwed in and serve as expansion compensators, which absorb the thermal expansion of the cables from the holding arm.

Regardless of the heater variant used, the glass dome is enclosed or attached to the outer tube of a tube-in-tube system that forms a vacuum ring gap, whereby the inner tube can protrude slightly beyond the outer tube and be connected or welded in a vacuum-tight manner to the welding receptacle of the solar heater. From the welding fixture, the supply and return lines can be led through the inner pipe into the outside space. Threads are provided at the ends of the pipes for screwing the sliding sleeves. The annular gap between the inner and outer pipe can be sealed vacuum-tight at the lower pipe ends. The welds of the solar heaters form thermal bridges to the outside. Since the heat flow through the double-walled pipe with poor heat conduction (e.g. stainless steel) has a long way to go to the fastening, whether bayonet lock or fastening flange, or to the glass frame, these areas can be considered as quasi “cold”. The heat flow is minimal. Damage to the glass frame due to heat and corresponding tensile stresses can be ruled out.

The mirrors should be as light as possible and yet still rigid and dimensionally stable. A sandwich construction, in which, for example, plastic foam is provided between the upper and lower mirrors, is advantageous in this regard. Upper and lower mirrors could be manufactured with the same tool. Due to its low weight, reflectability and deformability, aluminium appears to be a suitable material for deep drawing. The sheet material can be mirrored (upper mirror) or anodized (lower mirror) before deep drawing. The mirrors could be composed of segments of upper and lower mirrors that are glued together in an overlapping manner. This results in advantages in terms of manufacturing and tool costs. The mirror segments can be glued to the mirror stiffener over a large area or attached in another way. The mirror stiffener can be a welded part or a die-cast part made of aluminum. Rubber strips can be glued to the ends of the mirrors as a protective finish. The mirrors can be stacked securely on these edges. In addition to stiffening, designing the mirrors with double walls and foaming the gap between them has the advantage that hail damage can only occur on the outside, while the mirror surface remains intact. Further details are in the figure description (FIG. 7, FIG. 8).

The absorber units can be designed modularly so that different solar heaters can be used with the same external and connection dimensions. For heating heat transfer media without changing their state, such as: Spiral heaters can be used for heating media such as water, sea water, thermal oil, steam, compressed air, etc. These are very pressure-resistant and have a high heat transfer. The production of such spiral heaters is very simple. Deposits in the pipes can be easily removed by flushing with chemically reactive liquids (acids, bases). The choice of material can be tailored to the process media. This makes it possible to operate open processes, which is often advantageous in the food industry or in water treatment plants. Heat pipes, in particular heat pipes, which independently suck in the condensate via capillary action, can be used to generate process steam. With direct evaporation, processes can be regulated very precisely to the desired temperature. The main application will be in industry. Important areas of application will be solar power generation, seawater desalination and hydrogen production. During hydrogen production, saturated steam is generated at 30 bar. A partial flow of the steam generated is fed into the electrolysis station to separate hydrogen, —the remaining steam (>90%) is converted into electricity. Both the electrolysis station and the steam engine can optimally adapt to changing load conditions, as is common in solar energy. Another interesting application is the generation of electricity and heat in combination with fossil and biogenic fuels. Details about the heat pipes are in the figure description.

It is also possible to use refrigerants as heat transfer media. For the operation of absorption refrigeration systems, for example, the evaporation of the refrigerant can take place directly in the collectors. This eliminates the need for expensive heat exchangers in the absorption systems and leads to better performance.

The special shape of the mirror makes it possible to provide PV elements on the absorber surfaces, since the irradiation intensity on the power-generating surface is largely constant. The solar heater for evaporation is already modular and suitable for assembly. Evaporation allows the PV elements to be cooled evenly to the lowest possible temperatures. At cooling temperatures below 85° C., a refrigerant can be used, since water vapor in the lower temperature range has too high a specific volume to pass through the pipes. The hydraulic circuit is used for cooling unless the waste heat is additionally used. This is to be considered as an exception to the high-temperature systems. Details are in the figure description.

Automatic cleaning: In industrial applications, system blocks with a heating output of up to 1 MW are required. Here it makes sense to provide automatic cleaning, as manual cleaning represents a considerable cost factor. In collector systems with eight mirror units, the mirrors can close each other and form a closed interior space. Cleaning can be done, similar to the principle of a dishwasher, via nozzle heads that rotate around the central mirror axis. The lines provided with the nozzles, referred to here as nozzle unit, can be attached to a free-running rotating ring on the inside of the mirror. Free-running means that the rotating ring with the nozzle unit begins to rotate due to the impulse force when the nozzle is pushed out without its own drive. An inner ring can be fixedly connected to the flange for the bayonet lock and have a channel recess on the outside. The cleaning water can be supplied into the channel recess.

When the (outer) rotating ring is pushed over, the channel closes. The axial position of the rotating ring can be secured by guide bolts that are supported in the channel wall. The guide bolts can have holes through which the cleaning water reaches the nozzle units. Seals between the rotating ring and the inner ring are not required, but may be provided. A small leakage (up to 10%) is absolutely acceptable and can even be advantageous. This means that a gap between the inner ring and the rotating ring is water-lubricated, which reduces rotational resistance. In order to be able to thread the mirror over the absorber, the nozzle units can be removed. Therefore, a plug-in system with a stuffing box seal is recommended for connecting the nozzle units to the mirror. More details can be found in the figure description.

### BRIEF DESCRIPTION OF THE DRAWINGS

Preferred embodiments of the present invention are described in more detail below with reference to schematic drawings; however, the following description is not intended to exhaustively represent or restrict the concept of the invention. It shows:

FIG. 1 a mirror unit in exploded view,

FIG. 2 the mirror unit in the assembled state,

FIG. 3a, 3b two variants of a central stiffener for the mirror attachment,

FIG. 4a, 4b a bayonet lock,

FIG. 5 a section of a support arm with the retaining flange for the bayonet lock,

FIG. 6a, 6b a section of the support arm with a connection flange,

FIG. 7 two mirror variants assembled with the stiffener,

FIG. 8 the segmental structure of a mirror,

FIG. 9a, 9b, 9c, 9d four absorber units,

FIG. 10 the mirror geometry with the resulting angles of incidence,

FIG. 11 a partial view of an absorber unit,

FIG. 12a, 12b, 12c the structure of a heat pipe and the assembly of an evaporator unit,

FIG. 13a, 13b the removal of the heat pipes with heat conducting wings,

FIG. 14 the structure of a sliding sleeve for expansion compensation in section,

FIG. 15 the installation of the mirror units in a collector system with two mirrors,

FIG. 16 the packaging of an absorber unit for transport,

FIG. 17 a collector system with removed mirrors,

FIG. 18a, 18b Details of the bayonet lock of an absorber unit,

FIG. 19a, 19b a cleaning device with three fixed positioned nozzle heads,

FIG. 20 a cleaning device with two rotatable nozzle heads,

FIG. 21 the structure of a rotary distributor of the cleaning device.

### DETAILED DESCRIPTION

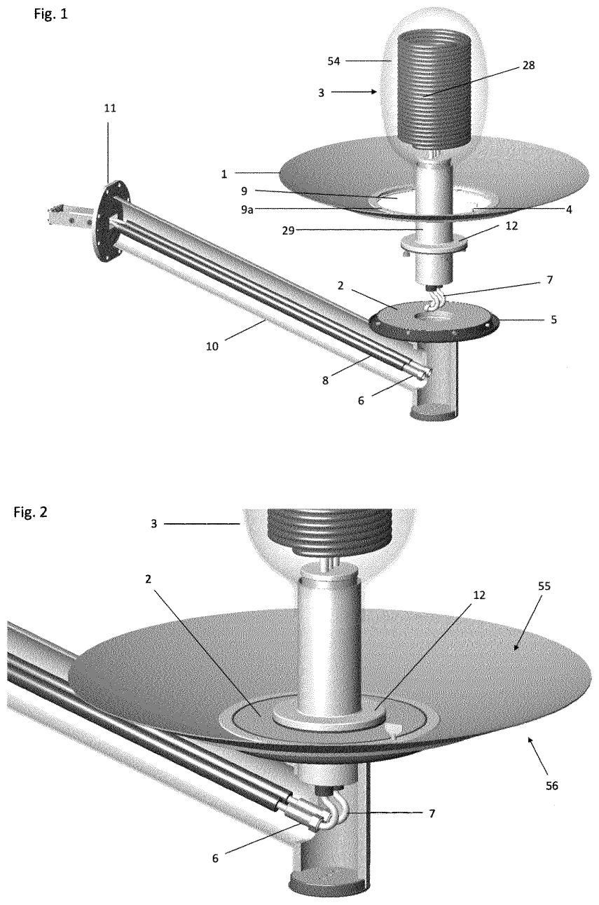

FIG. 1 shows the assembly sequence of a mirror unit according to the invention.

The central stiffener 1 of the mirror has a quick release fastener with an annular locking opening 9. A diameter of the annular closure opening 9 is slightly larger than a maximum diameter of an absorber unit 3. A support arm comprises a holding flange 2 with bolt locking, a connection flange 11, a support tube 10 and an internal piping 8. The mirror or the stiffener 1 as part of the mirror can be guided over the absorber unit 3 or threaded in and out. The retaining flange 2 of the support arm and the stiffener 1 form a bayonet lock, which can be opened by opening a locking bolt 4 by rotating the mirror or its stiffener 1 by a small angle. The bayonet lock or the holding flange 2 is sealed, whereby a seal 5 also facilitates the centering of the stiffener 1 on the holding flange 2. The absorber unit 3 can be mounted on the support flange 2 of the support arm. The hydraulic connection is made via two sliding sleeves 6 of the internal piping 8, which sliding sleeves 6 are screwed to line outlets 7 of the absorber unit 3 or are connected to them in another way. The sliding sleeves 6 are sealing when screwed together and simultaneously serve as expansion compensators which absorb the thermal expansion of the internal piping 8 and/or the line outlets 7 which occurs during normal operation of the device.

FIG. 2 shows a mirror unit in the assembled state. The absorber unit 3 is attached to the holding flange 2 of the support arm. The counter flange 12 of the absorber unit 3, via which counter flange 12 the absorber unit 3 is fastened to the holding flange 2 of the support arm, has blind holes in order to prevent corrosion caused by water penetrating at the screw connection points. Alternatively, the absorber unit 3 can also be connected to the support arm or its holding flange 2 by means of a bayonet lock, cf. FIGS. 18a, 18b. The sliding sleeves 6 are pushed forward, in the direction of the line outlets 7, and screwed to the line outlets 7. The mirror or its stiffener 1 can be mounted after the absorber units 3 have been installed. Preferably, the mirrors are mounted last.

The collector system can be placed in an easy-to-install position so that the mirrors are pointing downwards. Pushing the mirrors with their stiffeners 1 over the absorber units 3 and locking them in the bayonet lock is a simple and quick job.

FIGS. 3a and 3b show two variants of a central stiffener 1 for the mirrors. In variant 1 (FIG. 3a), the annular closure opening 9 is formed in one piece with the mirror stiffener 1, in particular welded; in other words: a closure element 9a forming the closure opening 9 is formed in one piece with a stiffening element 1a of the stiffener 1, in particular welded.

An upper mirror 14 can be glued to the stiffener 1, for example in such a way that the upper mirror 14 contacts the closure element 9a and/or is also connected, in particular glued, to the closure element 9a. Variant 2 (FIG. 3b) shows a stiffener 1 designed as a die-cast part 13, wherein the annular closure opening 9, which is made of steel for example, is inserted into the die-cast part 13 during casting and is thereby connected to it. The upper mirror 14 and the lower mirror 15 are glued to the die-cast part 13, which forms the stiffener 1 or the stiffening element 1a. The stiffening element 1a or the stiffener 1 can also be designed as a plastic part, in particular as a plastic injection-molded part. A foam filling 16 is provided between the upper mirror 14 and the lower mirror 15. These mirrors are very light and highly rigid. The foam 16 also serves as thermal insulation. This is a beneficial effect as it makes it possible to operate the collector systems without frost protection. To achieve this, heat loss through the pipes and absorber 3 must be minimized. With the light concentration, vacuum technology and also insulated mirrors that close together in the resting position, it is easy to prevent freezing. In most cases, the heat capacity of the piping systems and the working medium should be sufficient to avoid the need for additional heating. If the temperature If the temperature nevertheless drops to a critical value, warm medium can be buffered, for example from an external storage tank, in particular a 2-phase storage tank. In any case, the heat required for this will be minimal. It definitely has the ability to withstand extremely low temperatures for any length of time, even in areas where undiluted antifreeze would freeze.

In general, the upper mirror 14 can be attached, in particular glued, to an inner side 55 of the stiffening element 1a and/or the lower mirror 15 can be attached, in particular glued, to an outer side 56 of the (concave) stiffening element 1a.

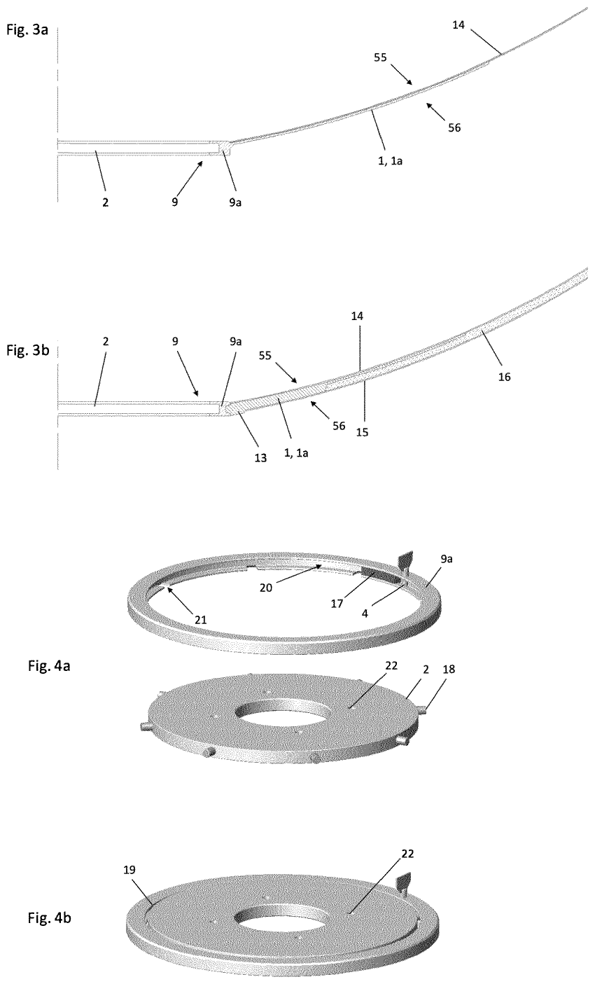

FIG. 4a shows the bayonet lock in an exploded view; FIG. 4b in an assembled state.

The locking element 9a forms an outer ring of the bayonet lock and has insertion openings 21, a jaw 17 and a locking bolt 4, wherein the locking bolt 4 can be screwed in and out. If the mirror is in the locking position, i.e. the retaining bolt 18 of the retaining flange 2 is at the stop to the jaw 17, the locking bolt 4 is screwed in. In its screwed-in state, the locking bolt 4 prevents rotation of the locking element 9a relative to the retaining flange 2. In the connected state (FIG. 4b) there is a gap 19 of approximately 3.5 mm between the annular closure opening 9 and the retaining flange 2. This is twice the size of a laser cut. This means that both components can be cut out of one plate in a way that saves material and reduces waste, while still leaving enough material for mechanical processing. The retaining bolts 18 are pressed into front-side bores in the retaining flange 2 or are formed integrally with the retaining flange 2. Ideally, the retaining bolts 18 are hardened. In the variant shown, the holding flange 2 has four through holes 22 for fastening the absorber unit 3 or the counter flange 12. The retaining flange 2 is a welded part of the support arm, or can be formed integrally with it. The closure element 9a has a guide recess 20 for receiving the bolts 18, which guide recess 20 is accessible via insertion openings 21 for the bolts 18.

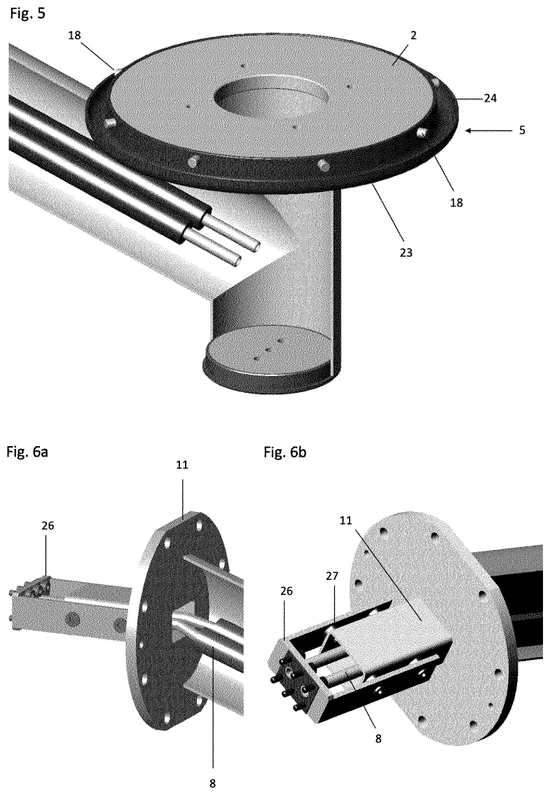

FIG. 5 shows a section of the support arm with the holding flange 2, on which holding flange 2 the holding bolts 18 are provided as part of the bayonet lock. The retaining flange 2 has a seal 23 at least on the front side, which seal 23 in the assembled state fills the annular gap 19 between the retaining flange 2 and the closure element 9a of the stiffener 1. The seal 23 also serves to center the mirror or its stiffening 1 on the holding flange 2. In order to cover the insertion openings 21 of the closure element 9a, the seal 23 has a radially outwardly extending projection to form a sealing lip 24. In the embodiment shown, the projection has a semicircular profile and engages under the closure element 9a in its fastened state and/or rests against it. The outer sealing lip 24 rests on the rear or underside of the closure opening 9 or the closure element 9a and prevents dirt and water from penetrating into the guide recess 20 of the bayonet lock via the insertion openings 21.

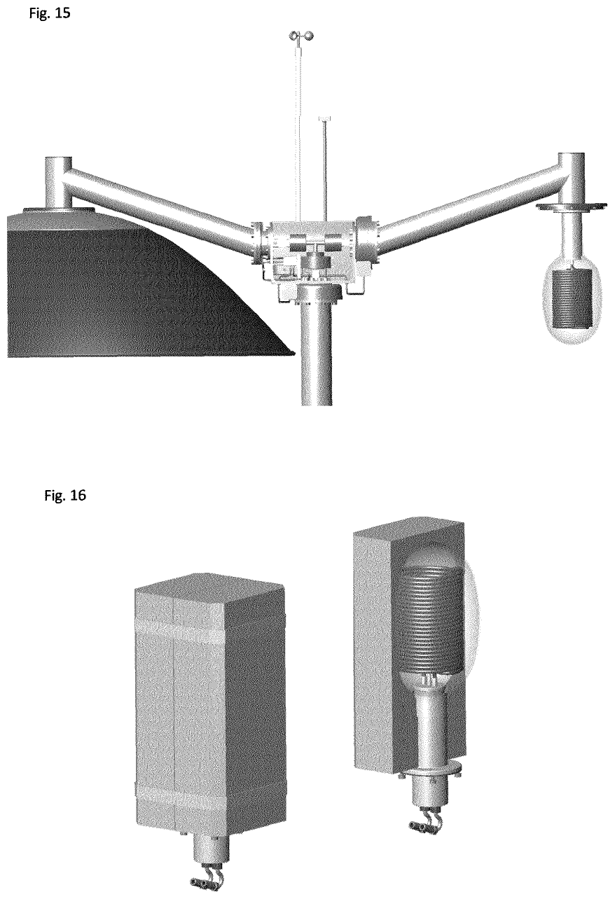

FIGS. 6a and 6b show apart of the support arm with the connection flange 11 in two views. What can be seen is the internal piping 8 8 hydraulic piping, which is connected, preferably welded, to a sealing flange 26 of the support arm. In order to avoid a thermal bridge, a suspension of the sealing flange 26 is mounted on the connecting flange 11 via insulating jaws 27. Although not shown here, it is understood that the internal piping 8 hydraulic pipes can be well insulated or foamed. The insulation, which can be seen here on the pipes 8 in the indicated area, is incomplete and is only intended for the high-temperature area in the immediate vicinity of the pipe. The connection flange is used to attach the support arm to a post or to a tracking unit of a solar or collector system; the sealing flange 26 is used to create a sealing (fluidic) connection between the piping of the support arm and a distribution unit of the solar or collector system cf. FIG. 15.

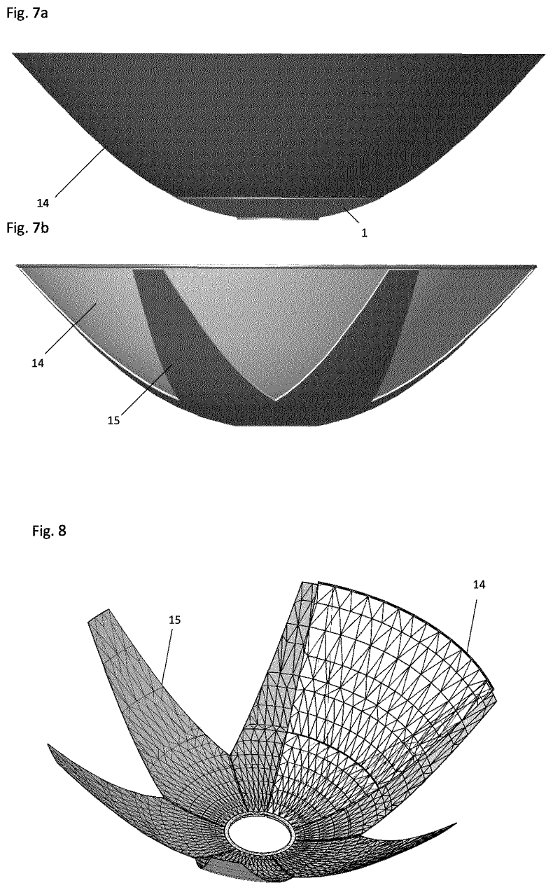

FIGS. 7a and 7b show two mirror variants assembled with the stiffener 1. Variant FIG. 7a shows the stiffener 1 with the upper mirror 14, which can be mounted self-supporting on the stiffener. Here variant 1 of the stiffener 1, as shown in FIG. 3, is used. Variant 2 FIG. 7b shows an assembled mirror with upper mirror 14 and lower mirror 15, wherein upper mirror 14 and lower mirror 15 are in turn attached to the stiffening element 1a. The stiffener 1 is designed according to variant 2, as shown in FIG. 3. The lower mirror 15 does not have to cover the upper mirror 14 completely, but can be formed by several segments that do not cover the entire mirror circumference. The stiffener 1 or the stiffening element 1a and the foam 16 or another intermediate insert can be seen at the edges of the lower mirror 15. A continuous covering of the lower mirror 14 naturally leads to the desired thermal insulation, as already mentioned above, and is therefore preferred.

FIG. 8 shows a segmented structure of a mirror. The segments of the upper and lower mirrors 14, 15 are glued or joined in an overlapping manner. This can be done by Stiffening element 1a according to variant 1 or variant 2 can be used. The advantage is that the costs for the deep-drawing tool for a segment are many times lower than for a full mirror. Furthermore, the degree of deformation is relatively low (a single pressing is sufficient).

In general, therefore, an embodiment is preferred in which a mirror with a stiffening element 1a is provided, to which stiffening element 1a either only an upper mirror 14 or an upper mirror 14 and a lower mirror 15 is/are attached, preferably glued, wherein the upper mirror 14 and/or lower mirror 15 are not designed as a full-surface mirror, for example as a paraboloid mirror, but only in segments. This is independent of other features described in the present application.

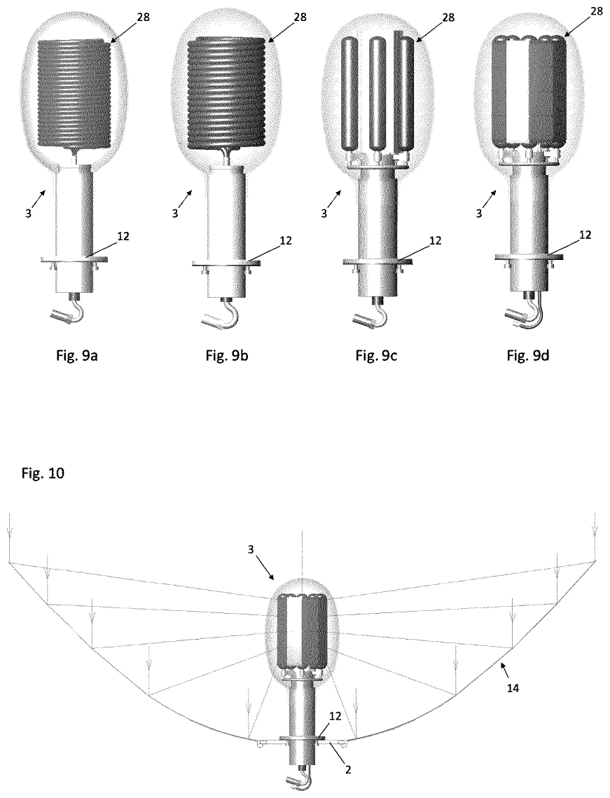

FIG. 9a, 9b, 9c and 9d show four absorber units 3. These differ in the heating systems used. Variants 1 and 2 have instantaneous water heaters with coiled tubing. Variants 3 and 4 have heat pipes. Variant 4 shows the possibility of equipping it with solar cells. The tube coils of the embodiment of the absorber unit shown in FIG. 9b have, in comparison to the embodiment shown in FIG. 9a, a larger diameter in order to be able to carry a higher (steam) volume.

FIG. 10 shows the mirror geometry of a mirror according to the invention with the resulting angles of incidence and beam paths to the absorber unit 3 arranged centered on the mirror. The subdivision of the irradiation shown is chosen such that equal-sized normal irradiation areas are covered. As can be seen from the example of solar cells, the result is that the radiation intensity on the solar cells is constant. The angle of incidence on the glass cover is approximately normal in all areas.

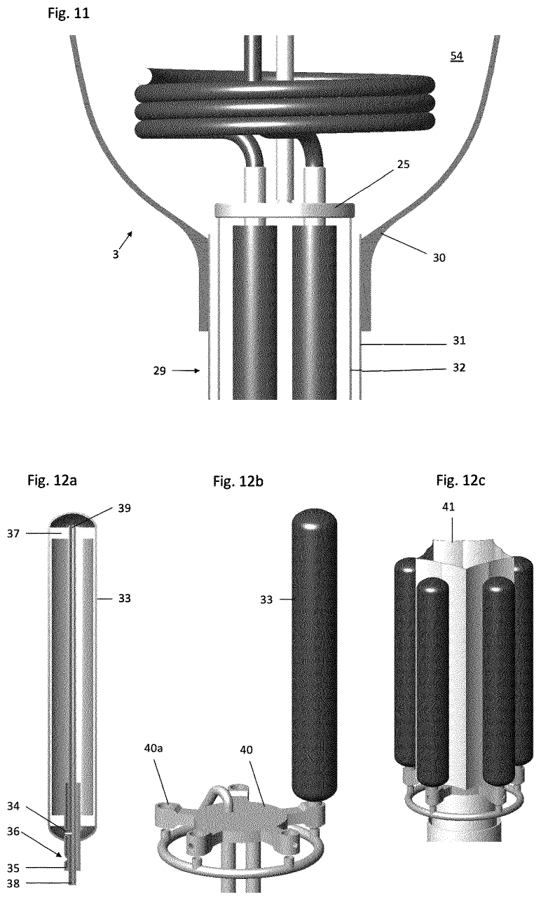

FIG. 11 shows a detail of an absorber unit 3 according to the invention.

What is essential is the double-walled support of the glass frame with a vacuum ring gap between the inner tube 32 and the outer tube 31. The glass 30, the glass enclosure of the absorber unit 3, has no thermal load since it is connected to the outer pipe 31 of the pipe-in-pipe system. The inner tube 32 and the outer tube 31 are welded at the ends, preferably at the ends facing away from the glass dome 30.

Regardless of the heater variant used (see FIG. 9a, 9b, 9c, 9d and related description), the glass dome 30 can be attached to the outer tube 31 of the tube-in-tube System which forms a vacuum ring gap, wherein the inner tube 32 can protrude slightly beyond the outer tube 31 and can be connected or welded in a vacuum-tight manner to a welding receptacle 25 of the solar heater. From the welding receptacle 25, the supply and return lines can be led through the inner pipe 32 into the outside space. At the ends of the supply and return lines, i.e. at line outlet 7, 6 threads are provided for screwing the sliding sleeves. The annular gap between the inner tube 32 and the outer tube 31 can be sealed vacuum-tight at the lower tube ends facing away from the glass dome 30. The welds of the solar heaters form thermal bridges to the outside. Since the heat flow through the double-walled pipe (pipe-in-pipe system) with poor heat conduction, for example made of stainless steel, has a long way to go to the fastening or to the glass frame, whether it is a bayonet lock or a fastening flange, these areas are to be considered as quasi “cold”. The heat flow is minimal. Damage to the glass frame due to heat and corresponding tensile stresses can be ruled out.

FIG. 12a shows the structure of a heat pipe according to the invention, and FIGS. 12b and 12c show the assembly in the heating system and in the absorber unit 3 solar heater, respectively. The heat pipes have a pressure vessel 33, a capillary suction lining 37, a steam-dissipating outer tube 35 with an outlet opening 36 and an inner tube 38 for the condensate supply with a lower outlet 34 and an upper outlet 39. The inner tube 38 and the outer tube 35 are welded. The capillary suction lining 37 has bottoms with sealing pipe penetrations. The heat pipes are inserted into a distribution unit 40 with, for example, five, receptacles 40a and soldered. In order to be able to completely absorb the incident radiation or to direct it to a rear side of the heat pipes, a reflector 41 can be provided, which reflector 41 can extend parallel to a longitudinal axis of the heat pipes from the distribution unit 40 and can be arranged, for example, in a sleeve-shaped manner in an inner region surrounded by the heat pipes. However, the reflector 41 does not have to have a cylindrical cross-section; any other cross-sections are also conceivable, for example the cross-section of an approximate pentagon as shown in FIG. 12c. The specific shape of the collector 41 can be selected depending on the heating elements 28 used and their geometry so that radiation passing by the heating elements 28 is redirected to the back of the heating elements 28.

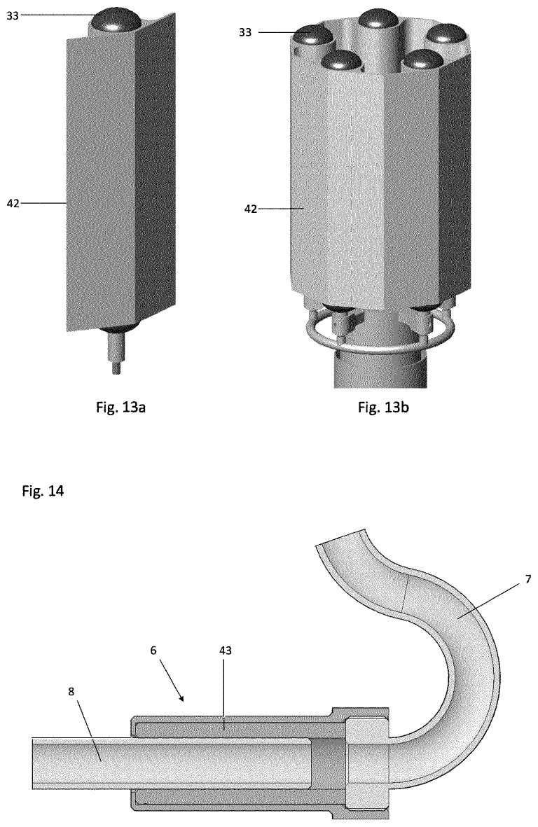

FIG. 13a shows the removal of the heat pipes with heat conducting fins 42. In order to be able to completely absorb the incident solar radiation, heat-conducting wings 42 can be provided. These can also be equipped with solar cells. The heat conducting wings 42 can be pushed or pressed onto the pressure vessels 33; for this purpose, the heat-conducting wings 42 can each have a receiving opening, which receiving opening is matched to the diameter of the pressure vessels 33 of the heat pipes. The receiving openings of the heat conducting wings 42 can also be dimensioned such that a press fit on the pressure vessel 33 results, whereby the pressure resistance of the heating elements 28, in particular heat pipes, can be further improved. The heat conducting wings 42 can be dimensioned such that the heat conducting wings 42 of adjacent heat pipes are in contact with each other when the heat pipes are connected to the distribution unit 40 as intended; alternatively, the heat conducting wings 42 attached to the individual heat pipes can also be formed integrally with each other, as shown in FIG. 13b.

FIG. 14 shows a sectional view of a connection between the inner piping 8 of the support arm and the line outlet 7 of the absorber unit 3 by means of the sliding sleeve 6 for expansion compensation. This is basically a stuffing box system. For a sealing sleeve 43 of the sliding sleeve 6 preferably a temperature-resistant material with good sliding properties is used. At temperatures below 250° C., Teflon can be used, for example, and at higher temperatures, ceramic materials.

FIG. 15 shows a collector system with two mirrors, whereby in the illustrated assembly state only the left support arm is provided with a mirror and no mirror is mounted on the right support arm. For assembly and disassembly, the support arms are positioned so that the mirrors are pointing downwards as shown.

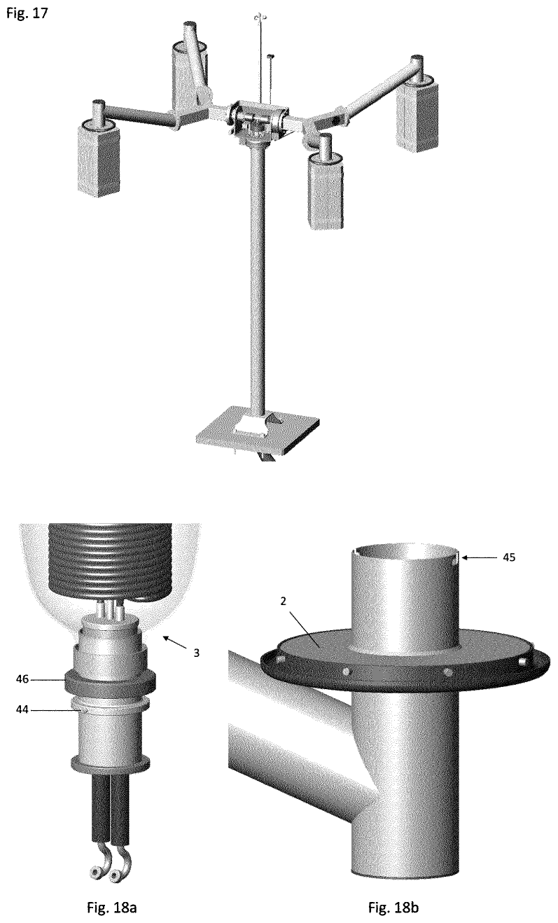

FIG. 16 shows the packaging of an absorber unit 3 for transport. The two-part design of the packaging, the housings of which are preferably made of plastic, in particular polystyrene, expanded polystyrene and/or extruded polystyrene, and the detachable connection of the two housing parts of this packaging, for example by means of adhesive tape, make it possible to reuse the packaging.

FIG. 17 shows a collector system with removed mirrors and packaged absorber units 3.

The packaging serves to protect the glass domes 30 and the heat pipes. The system is designed to accommodate four mirror units and has four support arms for this purpose. As can be seen, the areas exposed to wind are greatly reduced, especially when the mirrors are removed.

FIGS. 18a and 18b show a bayonet lock via which the support arm is connected to an absorber unit 3. This simplifies the assembly and disassembly of the absorber unit 3. Retaining bolts 44 Bolts of the absorber unit 3 are inserted into guide slots 45 of the support arm and locked by twisting. Subsequently, a seal 46, which seal 46 can already be attached to the absorber unit 3 before it is connected to the support arm, is pushed over the retaining bolts 44 or the guide slots 45. An anti-twisting device is not provided because the hydraulic connection does not allow any twisting, i.e. the absorber unit 3 can no longer be twisted after the fluidic connection between the line outlet 7 and the inner piping 8 has been established, at least not to such an extent that it would be possible to guide the retaining bolts 44 out of the guide slots 45. The variant with the bayonet lock is more cost-effective and practical than the variant in which the absorber unit 3 is screwed to the holding flange 2 (cf. FIGS. 1 and 2). Thus, if there is concern that the glass 30 of the absorber unit 3 will break because strong storms are forecast, the absorber unit 3 can be dismantled by one person in a few simple steps after opening both sliding sleeves 6. For this purpose, a part of the support tube 10 located in the area of the sliding sleeves 6 can be formed by a removable cover, which cover can preferably be provided with a seal.

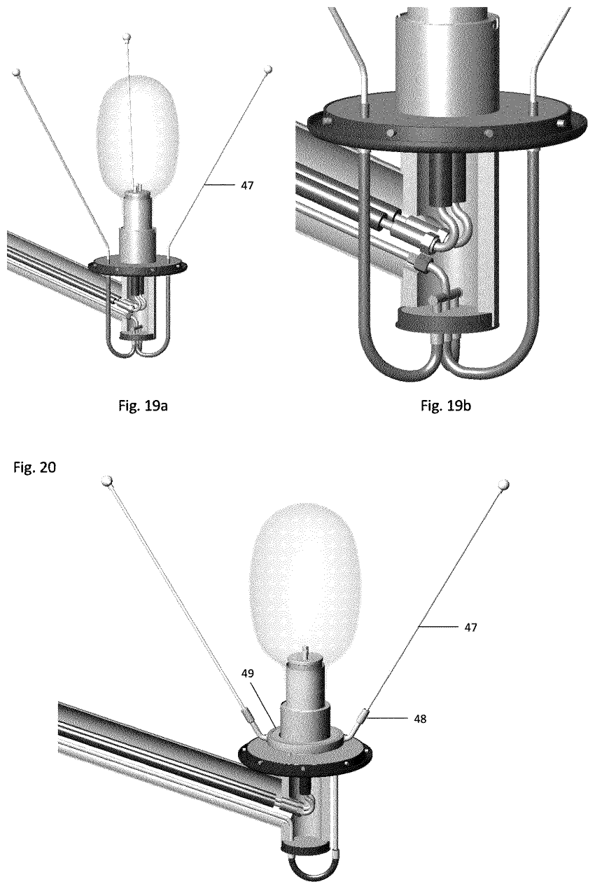

FIGS. 19a and 19b show the installation of a cleaning device with a nozzle unit 47 with three fixedly positioned nozzle heads. The nozzle unit 47 must be removed before removing the mirror.

FIG. 20 shows the installation of another cleaning device with a nozzle unit 47 with two rotatable nozzle heads. The rotation is made possible by a rotary distributor 49. The nozzle units 47 can be quickly assembled and disassembled by loosening a seal, in particular a stuffing box seal 48.

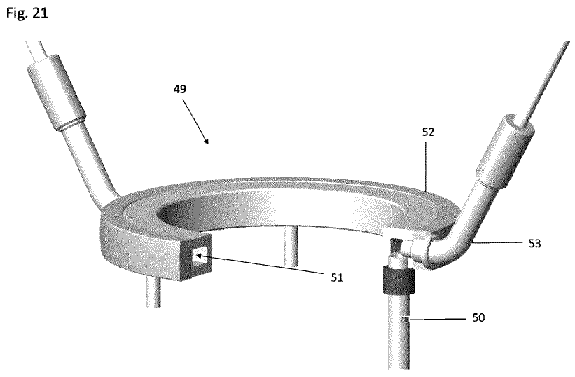

FIG. 21 shows a detail of the rotary distributor 49. The rotary distributor 49 has an inner ring with a channel 51 and an outer ring 52. The supply line 50 of a cleaning liquid is fed into the inner ring 51. The discharge takes place via nozzle 53 with a bore. The nozzles 53 are guided in the channel and thus position the outer ring 52 on the inner ring 51. A seal is not required as a precise fit is sufficient. A small gap may even be desirable, as the rotation should be smooth and the leakage of the cleaning fluid can serve as lubrication.

A mirror unit is preferred in which the mirrors have a central stiffener 1 with an annular quick-release fastener 9a, so that they can be mounted and dismounted purely by twisting the retaining flange 2 of the support arm.

Preferred is a mirror unit in which the holding flange 2 has a seal 5 for the bayonet lock.

Preferred is a mirror unit in which the mirror consists of or comprises an upper mirror 14 and a lower mirror 15.

Preferred is a mirror unit in which a foam or intermediate insert 16 is provided between the upper mirror 14 and the lower mirror 15.

Preferred is a mirror unit in which the upper mirror 14 and/or lower mirror 15 are arranged in segmental overlapping manner.

Preferred is a mirror unit in which the absorber unit 3 has a bayonet lock for connecting the absorber unit to the support arm.

Preferred is a mirror unit in which the absorber unit 3 has a double-walled holder 29 with an outer tube 31 and an inner tube 32.

A mirror unit is preferred in which sliding sleeves 6 are provided for the hydraulic connection of the absorber unit 3 to the inner piping 8 of the support arm.

A mirror unit is preferred in which the absorber units 3 have heat pipes, the heat pipes comprising a pressure vessel 33, a capillary suction lining 37, a steam-discharging pipe 35 with an outlet opening 36 and an inner pipe 38 with a lower outlet 34 and/or an upper outlet 39.

A mirror unit is preferred in which the heat pipes are accommodated in receptacles of a distribution unit 40, in particular inserted and soldered.

A mirror unit in which a reflector 41 is provided is preferred.

Preferred is a mirror unit in which heat-conducting wings 42 are pushed onto the heat pipes or are attached to them.

A mirror unit is preferred in which a cleaning device with a rotary distributor 49 is provided, comprising an inner ring with a channel 51, an outer ring 52, a supply line 50 and nozzles (or bolts) 53 with bores, wherein the nozzles 53 (or bolts 53) merge into line nozzles on which the nozzle units 47 of the cleaning device are mounted.

### LIST OF REFERENCE NUMBERS

1 stiffening
1a stiffening element
2 holding flange
3 absorber unit
4 locking bolt
5 seal
6 sliding sleeve
7 line output
8 internal piping
9 shutter opening
9a locking element
10 support tube
11 connection flange
12 counter flange
13 die-cast part
14 upper mirror
15 lower mirror
16 foam filling
17 jaw
18 retaining bolt
19 annular gap
20 guide recess
21 slot openings
22 through holes
23 seal
24 sealing lip
25 welding receptacle
26 sealing flange
27 insulating jaws
28 heating element
29 holder
30 glass (dome)
31 outer tube
32 inner tube
33 pressure vessel
34 lower outlet
35 outer tube of heat pipe
36 outlet opening
37 lining
38 inner tube of heat pipe
39 upper outlet
40 distribution unit
40a holder for the distribution unit
41 reflector
42 heat conducting wings
43 sealing sleeve
44 retaining bolt
45 guide slots
46 sealing
47 nozzle unit
48 stuffing box seal
49 rotary distributor
50 supply line
51 inner ring channel
52 outer ring
53 support
54 recording volume
55 inside
56 outside

1-37. (canceled)

38. An absorber unit for a solar collector or a solar system, comprising:
at least one heating element configured to guide a heat transfer medium;
a translucent enclosure enclosing at least one of the at least one heating elements, preferably all of the heating elements; and
a holder for the enclosure, the holder comprising an inner tube and an outer tube;
wherein the enclosure is fastened to the outer tube; and
wherein at least one of a supply line and a return line for the heat transfer medium is guided in the inner tube.

39. The absorber unit according to claim 38, wherein the enclosure is formed by a glass dome.

40. The absorber unit according to claim 38, wherein:
an annular gap is formed between the inner tube and the outer tube, the annular gap opening into a receiving volume of the enclosure; and
the inner tube is closed at an end facing the receiving volume.

41. The absorber unit according to claim 40, wherein a receptacle for the heating element closes the inner tube at an end facing the receiving volume.

42. The absorber unit according to claim 40, wherein the annular gap is closed at an end of the holder facing away from the receiving volume.

43. The absorber unit according to claim 38, wherein the inner tube is welded to the outer tube at the end of the holder facing away from the receiving volume.

44. The absorber unit according to claim 40, wherein the inner tube projects beyond the outer tube with an end facing the receiving volume.

45. The absorber unit according to claim 38, wherein the heating element is formed by a heat exchanger or comprises the heat exchanger.

46. The absorber unit according to claim 38, wherein the heating element is formed by or comprises a continuous-flow heater with tubular coils.

47. The absorber unit according to claim 38, wherein the heating element is formed by or comprises a two-phase thermosiphon.

48. The absorber unit according to claim 38, wherein the heating element is formed by a heat pipe or comprises the heat pipe.

49. The absorber unit according to claim 48, wherein:
the heat pipe comprises a pressure vessel, a capillary suction layer or lining, and an outer tube for discharging the heat transfer medium from the pressure vessel;
the outer tube has an outlet opening opening outside the pressure vessel, and an inner tube for supplying the heat transfer medium into the pressure vessel; and
the inner tube has a first outlet and a second outlet, the first outlet and second outlet opening inside the pressure vessel.

50. The absorber unit according to claim 48, wherein:
a distributor unit with a plurality of receptacles is provided, in or on which receptacles a heat pipe is fastened; and
the distributor unit establishes a connection between the inner tube and the outer tube of the heat pipes accommodated in or on the receptacles, and the supply line and the return line, respectively.

51. The absorber unit according to claim 50, wherein the distributor unit forms the receptacle for the heating element.

52. The absorber unit according to claim 38, wherein:
the absorber unit comprises at least one reflector; and
the at least one heating element is arranged between the reflector and the enclosure.

53. The absorber unit according to claim 52, wherein the reflector is fastened to the receptacle for the heating element or to the distributor unit and the reflector extends in the longitudinal direction of the heating element.

54. The absorber unit according to claim 38, wherein the at least one heating element is connected to heat-conducting vanes or formed integrally therewith in order to increase the proportion of solar radiation absorbed by the heating element.

55. The absorber unit according to claim 54, wherein the heat conducting vanes of adjacent heating elements touch one another or are formed integrally with one another.

56. The absorber unit according to claim 54, wherein the heat-conducting wings have solar cells on an outer side facing the enclosure.

57. The absorber unit according to claim 38, wherein provided on the holder are at least one of:
a counter flange for screwing the absorber unit to a holding flange of a support arm of the solar collector or the solar system;
holding bolts for engaging in guide slots of a support arm of the solar collector or the solar system; and
guide slots for receiving holding bolts of a support arm of the solar collector or the solar system.

58. The absorber unit according to claim 38, wherein a line outlet of the flow line and/or the return line has threads for fastening one or more sliding sleeves in order to sealingly connect at least one of the flow line and the return line to an internal piping of a support arm of the solar collector or the solar system.
